(19) United States
(12) Patent Application Publication
(10) Pub. No.: US 2008/0050629 A1
(43) Pub. Date: Feb. 28, 2008

(54) APPARATUS AND METHOD FOR MANAGING A FLOW OF COOLING MEDIA IN A FUEL CELL STACK

(76) Inventors: Bruce Lin, Mississauga (CA); Alfred Ngan Fai Wong, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/843,278

(22) Filed: Aug. 22, 2007

Related U.S. Application Data
(60) Provisional application No. 60/966,525, filed on Aug. 25, 2006.

(51) Int. Cl. H01M 8/04; H01M 8/24

(52) U.S. Cl. 429/26

(57) ABSTRACT

An apparatus and method for managing cooling characteristics of a fuel cell stack in distinct regions thereof, the fuel cell stack having a plurality of fuel cells, each fuel cell comprising a membrane electrode assembly (MEA), at least one flow field plate interposed between the MEAs of adjacent fuel cells, the flow field plates forming coolant flow field channels on a side of the flow field plates opposing the MEAs and reactant flow field channels on a side of the flow field plates adjacent the MEAs, comprises selectively isolating two distinct volumes in each coolant flow field channel, for example via at least one fluid-tight dividing member, and circulating and/or sealing at least two fluids respectively having distinct characteristics in distinct volumes of the coolant flow field channels to variably manage a rate of cooling in distinct regions of the fuel cell stack.

### CROSS-REFERENCE TO RELATED APPLICATION

This application claims the benefit under 35 U.S.C. § 119(e) of U.S. Provisional Patent Application No. 60/______, filed Aug. 25, 2006 (formerly U.S. application Ser. No. 11/467,307, converted to provisional by Petition dated Aug. 9, 2007), which provisional application is incorporated herein by reference in its entirety.

### BACKGROUND

1. Field

The present invention is generally directed to electrochemical converters such as fuel cells, and more particularly, to an apparatus and method for managing a flow of a cooling media in a fuel cell stack.

2. Description of the Related Art

Electrochemical cells comprising ion exchange membranes, such as proton exchange membranes (PEMS) may be operated as fuel cells, wherein a fuel and an oxidant are electrochemically converted at the cell electrodes to produce electrical power, or as electrolyzers, wherein an external electrical current is passed between the cell electrodes, typically through water, resulting in generation of hydrogen and oxygen at the respective electrodes. FIGS. 1-3 collectively illustrate a typical design of a conventional membrane electrode assembly 5, an electrochemical fuel cell 10 comprising a PEM layer 2, and a stack 50 of such cells.

Each fuel cell 10 comprises a membrane electrode assembly (MEA) 5 such as that illustrated in an exploded view in FIG. 1. The MEA 5 comprises an ion exchange membrane 2 interposed between first and second electrode layers 1, 3, which are typically porous and electrically conductive. The electrode layers 1, 3 typically comprise a gas diffusion layer and an electrocatalyst typically positioned at an interface with the ion-exchange membrane 2 for promoting the desired electrochemical reaction.

In an individual fuel cell 10, illustrated in an exploded view in FIG. 2, an MEA 5 is interposed between first and second flow field plates 11, 12, which are typically fluid impermeable and electrically conductive. The flow field plates 11, 12 are manufactured from non-metals, such as graphite; from metals, such as certain grades of steel or surface treated metals; or from electrically conductive plastic composite materials.

Electrochemical fuel cells 10 with ion exchange membranes 2 such as PEM layers, sometimes called PEM cells, are typically advantageously stacked to form a stack 50 (see FIG. 3) comprising a plurality of cells disposed between first and second end plates 17, 18. A compression mechanism is typically employed to hold the fuel cells 10 tightly together, to maintain good electrical contact between components, and to compress the seals. In the embodiment illustrated in FIG. 2, each fuel cell 10 comprises a pair of flow field plates 11, 12 in a configuration with two flow field plates per MEA 5. Cooling spaces or layers may be provided between some or all of the adjacent pairs of flow field plates 11, 12 in the stack 50. An alternate configuration may include a single flow field plate, or bipolar plate, that can be unitary or made up of two half plates interposed between a pair of MEAs 5 contacting the cathode of one cell and the anode of the adjacent cell, thus resulting in only one flow field plate per MEA 5 in the stack 50 (except for the end cell). Such a stack 50 may comprise a cooling layer interposed between every few fuel cells 10 of the stack 50, rather than between each adjacent pair of fuel cells 10.

The illustrated cell elements have openings 30 formed therein which, in the stacked assembly, align to form gas manifolds for supply and exhaust of reactants and products, respectively, and, if cooling spaces are provided, for a cooling medium.

FIG. 4 illustrates a conventional electrochemical fuel cell system 60, as more specifically described in U.S. Pat. Nos. 6,066,409 and 6,232,008, which are incorporated herein by reference. As shown, the fuel cell system 60 includes a pair of end plate assemblies 62, 64, and a plurality of stacked fuel cells 66, each comprising an MEA 68, and a pair of flow field plates 70. Between each adjacent pair of MEAs 68 in the system 60, there are two flow field plates 70a, 70b, which have adjoining surfaces. The two plates 70 can be fabricated from a unitary plate forming a bipolar plate as discussed above. A tension member 72 extends between the end plate assemblies 62, 64 to retain and secure the system 60 in its assembled state. A spring 74 with clamping members 75 can grip an end of the tension member 72 to apply a compressive force to the fuel cells 66 of the system 60.

Fluid reactant streams are supplied to and exhausted from internal manifolds and passages in the system 60 via inlet and outlet ports 76 in the end plate assemblies 62, 64. Aligned internal reactant manifold openings 78, 80 in the MEAs 68 and flow field plates 70, respectively, form internal reactant manifolds extending through the system 60. As one of ordinary skill in the art will appreciate, in other representative electrochemical fuel cell stacks, reactant manifold openings may instead be positioned to form edge or external reactant manifolds.

In the illustrated embodiment, a perimeter seal 82 is provided around an outer edge of both sides of the MEA 68. Furthermore manifold seals 84 circumscribe the internal reactant manifold openings 78 on both sides of the MEA 68. When the system 60 is secured in its assembled, compressed state, the seals 82, 84 cooperate with the adjacent pair of plates 70 to fluidly isolate fuel and oxidant reactant streams in internal reactant manifolds and passages, thereby isolating one reactant stream from the other and preventing the streams from leaking from the system 60.

As illustrated in FIG. 4, each MEA 68 is positioned between the active surfaces of two flow field plates 70. Each flow field plate 70 has flow field channels 86 (partially shown) on the active surface thereof, which contacts the MEA 68 for distributing fuel or oxidant fluid streams to the active area of the contacted electrode of the MEA 68. In the embodiment illustrated in FIG. 4, the reactant flow field channels 86 on the active surface of the plates 70 fluidly communicate with the internal reactant manifold openings 80 in the plate 70 via reactant supply/exhaust passageways comprising backfeed channels 90 located on the non-active surface of the plate 70, the backfeed ports 92 extending through (i.e., penetrating the thickness) the plate 70, and transition regions 94 located on the active surface of the plate 70. As shown, with respect to one port 92, one end of the port 92 can open to the backfeed channel 90, which can in turn be open to the internal reactant manifold opening 80, and the other end of the port 92 can be open to the transition region 94, which can in turn be open to the reactant flow field channels 86.

Instead of two plates 70, one plate 70 unitarily formed or alternatively fabricated from two half plates 70a, 70b can be positioned between the cells 66, forming bipolar plates as discussed above.

In the illustrated embodiment, the flow field plates 70 also have a plurality of typically parallel flow field channels 96 formed in the non-active surface thereof. The channels 96 on adjoining pairs of plates 70 cooperate to form coolant flow fields 98 extending laterally between the opposing non-active surfaces of the adjacent fuel cells 66 of the system 60 (generally perpendicular to the stacking direction). A coolant stream, such as air or other cooling media may flow through these flow fields 98 to remove heat generated by exothermic electrochemical reactions, which are induced inside the fuel cell system 60.

The reactant flow field channels 86 generally include design parameters that accommodate desired reactant flow. These parameters can also govern the design of coolant flow field channels 96 because plate design is typically constrained by forming limitations. Generally, the flow field channels 86 on one side of the plate are balanced by the flow field channels 96 on the other side of the plate, particularly if the plate is made by stamping (more typical of metal plates).

However, such manufacturing and design limitations impede optimizing the coolant flow field channels 96, resulting in suboptimal coolant flow, typically because the coolant flow field channels 96 are excessively large and therefore contain an undesirably large volume of coolant. A large volume of coolant may increase the stack thermal mass, thereby slowing a warming up process during freeze-starts and ambient startups, and may adversely affect a route or direction of desired heat transfer as well as water movement between the anode and cathode sides of the MEA 68.

Furthermore, flow field plate manufacturing limitations prescribe a shape of the coolant flow field channels 96 such that it is typically not possible with existing systems to introduce distinct cooling media through distinct coolant flow field channels and/or to control the rate and/or quantity of coolant media in distinct coolant flow field channels 98. For example, it may be desirable to direct less cooling medium through the coolant flow field channels 98 of the fuel cells 66 positioned toward the end plates 62, 64. Additionally, or alternatively, it may be desirable to flow less cooling medium through the coolant flow field channels 98 positioned at an edge of the flow field plates 70 as compared to that flowing through the coolant flow field channels 98 positioned toward a center of the flow field plates 70. Additionally, or alternatively, it may be desirable in certain applications to cool the anode side more than the cathode side of the MEA 68. In other applications, it may be desirable to cool the cathode side more than the anode side of the MEA. Conventional flow field plates 70 typically fail to allow such control over cooling of distinct regions in the fuel cell system 60.

Furthermore, conventional solutions have also failed to adequately address controlling a temperature of the distinct regions in a fuel cell system. Conventional solutions include molding and/or machining non-metal flow field plates to vary the thickness of the web of the plates, resulting in more costly and time-consuming manufacturing. Furthermore, this solution is not amenable to use with metal plates.

Other methods include additional manufacturing steps such as machining, forming, etching, and/or molding that are typically carried out to form reactant and coolant flow field channels in separate manufacturing steps in order to achieve coolant flow field channels having a shape distinct from reactant flow field channels. Additionally, these processes are typically limited to specific materials, for example, they typically cannot be used for thin metal plates, the thickness of which may not be easily adjusted.

Accordingly, there is a need for a system and a method to manage a utilization of coolant flow field channels to accommodate a desired flow of distinct cooling media through the coolant flow field channels and selectively control a temperature of distinct regions of a fuel cell and/or of a fuel cell system by managing the cooling media flow through coolant flow field channels of flow field plates fabricated from any suitable material.

### BRIEF SUMMARY

According to one embodiment, a flow field plate assembly for use in a fuel cell stack having more than one fuel cell, each fuel cell including a membrane electrode assembly (MEA) having an ion-exchange membrane interposed between anode and cathode electrode layers, comprises a first flow field plate positionable on an anode side of the MEA of a first fuel cell, at least one reactant flow field channel formed in at least a portion of a first side of the first flow field plate adapted to direct a fuel to at least a portion of the anode electrode layer of the first fuel cell, a second flow field plate positionable on a cathode side of the MEA of a second fuel cell, adjacent the first fuel cell, at least one reactant flow field channel formed in at least a portion of a first side of the second flow field plate adapted to direct an oxygen-containing gas to at least a portion of the cathode electrode layer of the second fuel cell, at least one coolant flow field channel formed in at least a portion of a second side of the first and second flow field plates, respectively, the coolant flow field channels of the second side of the first flow field plate being positioned substantially opposite the coolant flow field channels of the second side of the second flow field plate to define an aggregate volume therebetween configured to direct a cooling medium therethrough, and at least one dividing member extending across at least one coolant flow field channel of at least one of the second sides to selectively divide the aggregate volume into at least first and second volumes, the first volume being configured to circulate or seal a first fluid having a first flow characteristic when circulated and a first composition, and the second volume being configured to circulate or seal a second fluid having a second flow characteristic when circulated and a second composition, to allow selective control over an aggregate cooling characteristic of the fuel cell stack, when the flow field plate assembly is installed in the fuel cell stack and the fuel cell stack is in operation.

According to another embodiment, a fuel cell stack comprises more than one fuel cell, each fuel cell including a membrane electrode assembly (MEA) having an ion-exchange membrane interposed between anode and cathode electrode layers, a first flow field plate positioned on an anode side of the MEA, at least one reactant flow field channel formed in at least a portion of a first side of the first flow field plate adapted to direct a fuel to at least a portion of the anode electrode layer, a second flow field plate positioned on a cathode side of the MEA, at least one reactant flow field channel formed in at least a portion of a first side of the second flow field plate adapted to direct an oxygen-containing gas to at least a portion of the cathode electrode layer, at least one coolant flow field channel formed in at least a portion of a second side of the first and second flow field plates, respectively, the coolant flow field channels of the second side of the first flow field plate of each fuel cell respectively positioned substantially opposite the coolant flow field channels of the second side of the second flow field plate of an adjacent fuel cell to define an aggregate volume therebetween configured to direct a cooling medium therethrough, and at least one dividing member extending across at least one coolant flow field channel of at least one of the second sides to selectively divide the aggregate volume into at least first and second volumes, the first volume being configured to circulate or seal a first fluid having a first flow characteristic when circulated and a first composition, and the second volume being configured to circulate or seal a second fluid having a second flow characteristic when circulated and a second composition, to allow selective control over an aggregate cooling characteristic of the fuel cell stack, when the flow field plate assembly is installed in the fuel cell stack and the fuel cell stack is in operation.

According to yet another embodiment, a method of selectively managing cooling characteristics of a fuel cell stack in distinct regions thereof, the fuel cell stack having a plurality of fuel cells, each fuel cell comprising a membrane electrode assembly (MEA) having an ion-exchange membrane interposed between anode and cathode electrode layers, at least one flow field plate interposed between the MEAs of adjacent fuel cells, the flow field plates forming a plurality of coolant flow field channels on a side of the flow field plates opposing the MEAs and a plurality of reactant flow field channels on a side of the flow field plates adjacent the MEAs, comprises positioning the coolant flow field channels of each flow field plate substantially opposite the coolant flow field channels of an adjacent flow field plate to define an aggregate volume between each pair of opposing coolant flow field channels, dividing each aggregate volume into at least two volumes, and at least one of directing and sealing at least two fluids through the at least two volumes, respectively, the two fluids comprising at least one of distinct flow characteristics when circulated and distinct compositions, to variably manage a rate of cooling in at least one of distinct regions of each fuel cell and distinct regions of the fuel cell stack.

### BRIEF DESCRIPTION OF THE SEVERAL VIEWS OF THE DRAWING(S)

FIG. 1 is an exploded isometric view of a membrane electrode assembly according to the prior art.

FIG. 2 is an exploded isometric view of a fuel cell according to the prior art.

FIG. 3 is an isometric view of a fuel cell stack according to the prior art.

FIG. 4 is an exploded isometric view of a fuel cell system according to the prior art.

FIG. 5 is an isometric view of a portion of a fuel cell stack according to an embodiment of the present invention.

FIG. 6 is a side view of a portion of two fuel cells of a fuel cell stack according to one embodiment of the present invention.

FIG. 7 is a side view of a portion of two fuel cells of a fuel cell stack according to another embodiment of the present invention.

FIG. 8 is a side view of a portion of two fuel cells of a fuel cell stack according to a further embodiment of the present invention.

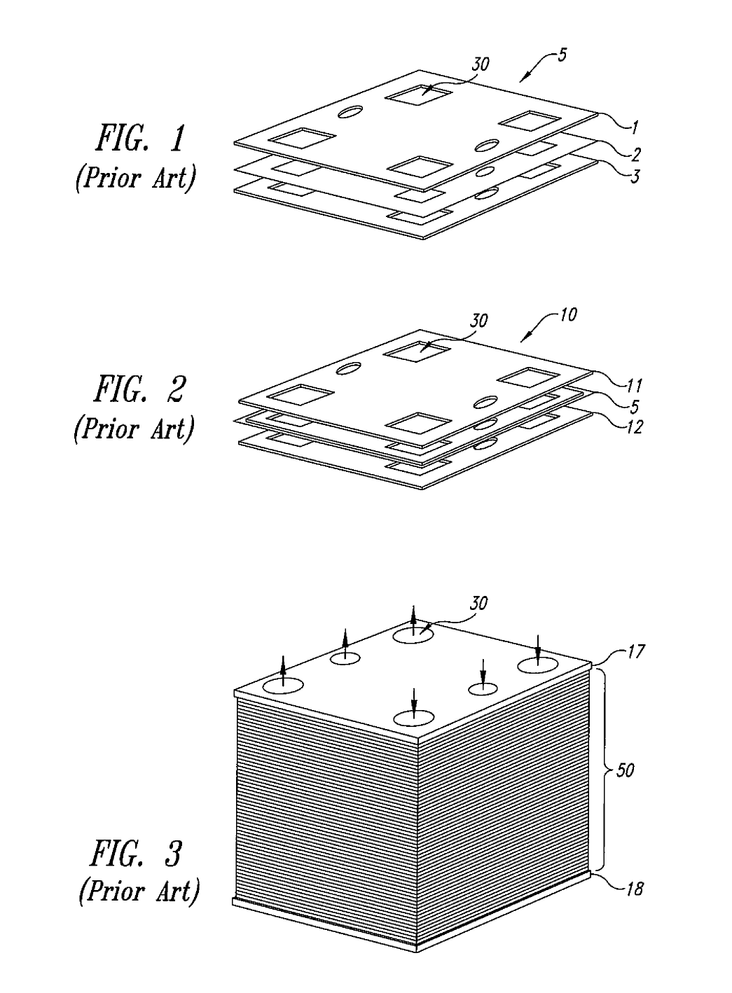

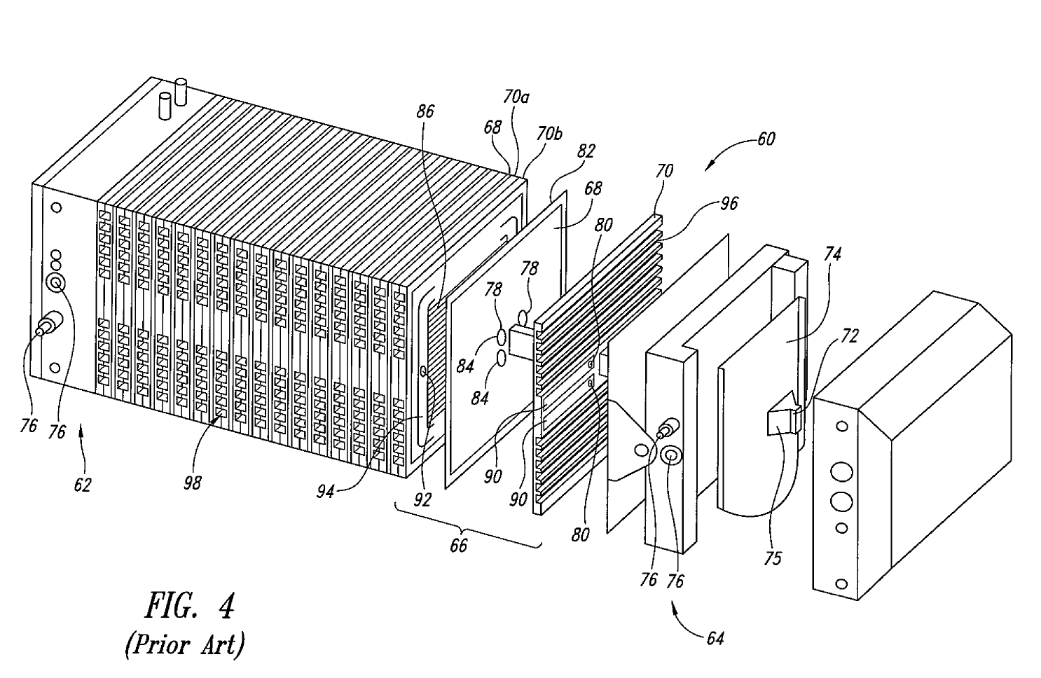

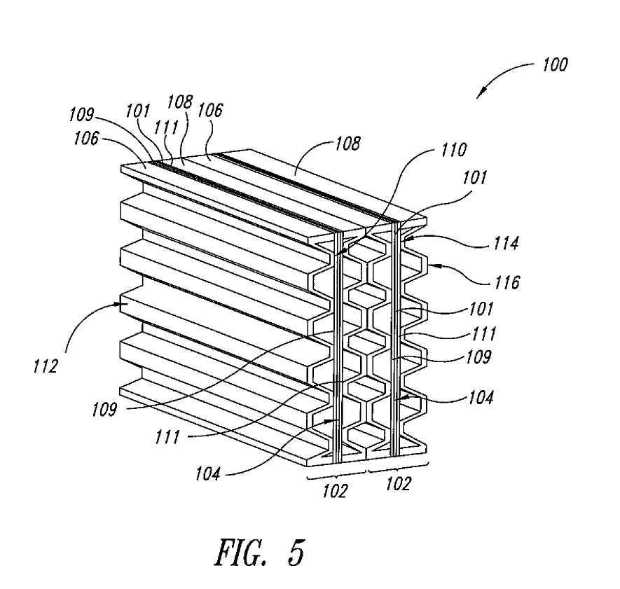

### DETAILED DESCRIPTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

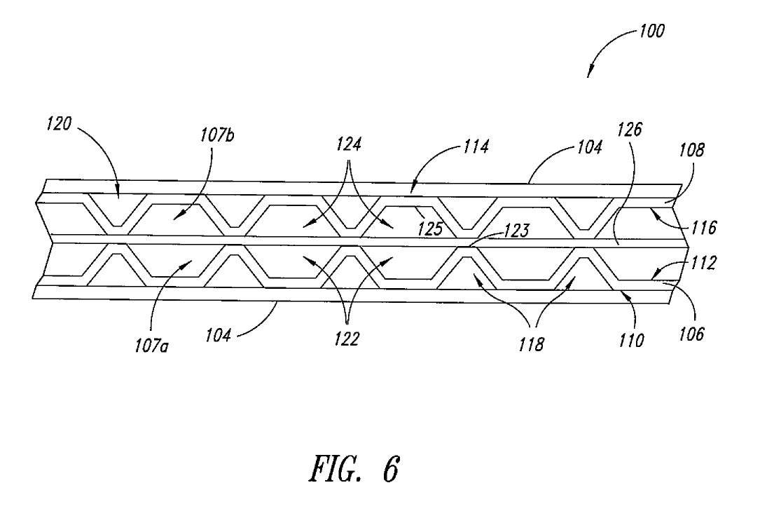

FIG. 5 illustrates a portion of a fuel cell stack 100 according to one embodiment. The fuel cell stack 100 comprises at least one fuel cell 102 or more than one fuel cell 102 forming the fuel cell stack 100. For clarity of description and illustration, FIG. 5 illustrates two adjacent fuel cells 102, each fuel cell 102 comprising a membrane electrode assembly (MEA) 104 interposed between first and second flow field plates or half plates 106, 108. The MEA 104 includes an ion-exchange membrane, such as a PEM 101, interposed between an anode layer 109 and a cathode layer 111. The first flow field plate 106 includes a first side 110 facing an anode side of the MEA 104 and a second side 112 opposing the MEA 104. Similarly, the second flow field plate 108 includes a first side 114 facing a cathode side of the MEA 104 and a second side 116 opposing the MEA 104.

FIG. 6 illustrates a portion of the fuel cell stack 100, illustrating a portion of the MEA 104 of adjacent fuel cells 102 (FIG. 5), the first flow field plate 106 of one of the MEAs 104 and the second flow field plate 108 of the other of the MEAs 104. The first flow field plate 106 comprises at least one reactant flow field channel 118 for directing and/or circulating a flow of a fuel, such as a hydrogen-containing fuel, to the anode side of the MEA 104. The second flow field plate 108 comprises at least one reactant flow field channel 120 for directing and/or circulating a flow of an oxygen-containing gas, such as air, to the cathode side of the MEA 104. Formation of the reactant flow field channels 118, 120 can also form coolant flow field channels 122, 124 on the second sides 112, 116 of the first and second flow field plates 106, 108, opposing the first sides 110, 114. The coolant flow field channels 122, 124 can comprise any recessed cross-sectional shape, one that has a peak 123 and a valley 125, such as a trapezoidal and/or a curvilinear cross-sectional shape, configured to direct a flow of a cooling medium therethrough.

Forming the coolant flow field channels 122, 124 simultaneously with forming the reactant flow field channels 118, 120 can eliminate additional manufacturing steps such as machining, forming, and/or etching that are typically carried out to form reactant and coolant flow field channels in separate manufacturing steps in order to achieve coolant flow field channels having a shape distinct from reactant flow field channels. Additionally, these processes are typically limited to specific materials, for example they typically cannot be used for thin metal plates, the thickness of which may not easily be adjusted. However, forming the coolant and reactant flow field channels 118, 120, 122, 124 in a single process such as molding or embossing graphite plates and/or stamping metal plates is less expensive, and more expedient and versatile toward different materials.

The flow field channels 118, 120, 122, 124 are sized based on reactant flow design parameters. These parameters determine a shape of the reactant flow field channels 118, 120, which in turn govern a shape of the coolant flow field channels 122, 124, particularly when stamping metal plates to form the flow field channels thereon. Accordingly, the coolant flow field channels 122, 124 need not necessarily be sized at this point in manufacturing to optimize the flow of the cooling medium directed therethrough, thereby reducing manufacturing time and costs.

According to an embodiment of the present invention, the fuel cell stack 100 further comprises a dividing member 126 that acts as an obstruction medium, selectively isolating a volume 107a, 107b of the coolant flow field channels 122 of the first flow field plate 106 from the volume 107a of other flow field channels 122 of the first flow field plate 106 and from the volume 107b of other coolant flow field channels 124 formed on the second flow field plate 108, permitting fluid flow, or blocking fluid from flowing, on either side of the dividing member 126. Therefore, if desired the volume 107a, 107b can selectively circulate or seal at least one of an oxygen-containing gas such as air, an inert gas such as nitrogen, and a liquid such as water and/or glycol or any other suitable cooling media. Introducing air into at least a portion of the volumes 107a, 107b promotes reducing the thermal mass in the coolant flow field channels 122, 124. Such a configuration can be used to induce a desired or controlled temperature gradient between the cathode and anode sides of the MEA 104 and force water movement to one of the cathode and anode sides of the MEA 104. Furthermore, the volumes 107a, 107b can selectively direct additional cooling medium where heightened cooling is desired.

For example, during ambient and freeze startups, cooling media can be directed and/or circulated through only certain isolated coolant flow field channels 122, 124, such as directing less cooling media through the coolant flow field channels 122, 124 positioned toward an edge of the flow field plates 106, 108 than that directed through the coolant flow field channels 122, 124 positioned toward a center of the flow field plates 106, 108. Additionally, or alternatively, less cooling media can be directed through the coolant flow field channels 122, 124 of the fuel cells 102 (FIG. 5) positioned toward an end of the fuel cell stack 103 (FIG. 5) proximate opposing end plates. Accordingly, distinct quantities, types and flow rates of a same or distinct cooling media can be directed through distinct coolant flow field channels at different times, for example first and second times, respectively corresponding to for example freeze startups and idle times to optimize a cooling characteristic of the fuel cell stack 100 and thus improve performance and durability thereof.

Additionally, or alternatively, at least some of the volumes 107a, 107b, or all of the volumes 107a, 107b of one of the flow field plates 106, 108 may stagnantly store and seal fluids such as water and/or air, for example sealing air in at least a portion of at least one of the volumes 107a, 107b, to obtain insulation qualities, control the thermal mass of the flow field plates 106, 108, or for any other suitable purpose depending on the application.

FIG. 7 illustrates another embodiment, in which a fuel cell stack 200 comprises at least two, or a plurality of dividing members 226. The dividing member 226 can be curvilinear or mounted at an angle with respect to a direction in which the first and second flow field plates 206, 208 extend to manipulate a flow characteristic of the cooling medium, such as the flow rate thereof. Further, a separate dividing member 226 can be mounted across distinct flow field channels 222, 224. For example, a curvilinear dividing member 226 can be positioned across at least a portion of the flow field channels 222 of the first flow field plate opposing a dividing member 226 of the opposing flow field channel 224 of the second flow field plate 208, which may take any shape for example rectilinear or curvilinear, the two dividing members 226 forming a coolant flow path 230. The flow path 230 may extend in any direction, for example in a direction substantially parallel to a direction of the flow of the cooling medium. The cross-sectional shape of the flow path 230 can be varied. For example, the flow path 230 can be narrowed in a direction parallel to a direction along which the flow field channels 222, 224 extend or from an inlet to an outlet of the flow path 230.

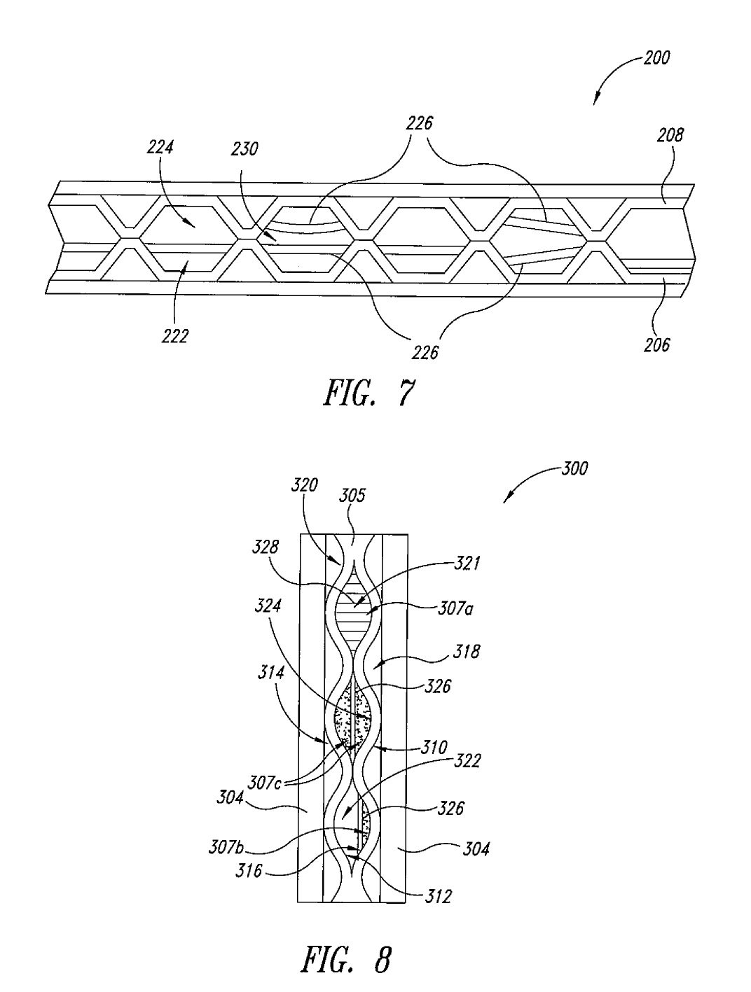

FIG. 8 illustrates a further embodiment, in which a fuel cell stack 300 comprises a bipolar plate 305 having inner surfaces 312, 316, at least partially facing each other, in which coolant flow field channels 321, 322, 324 are formed. The stack 300 further includes outer surfaces 310, 314, in which reactant flow field channels 318, 320 are formed adjacent the MEAs 304 of the adjacent fuel cells. A dividing member or a plurality of dividing members 326 can be mounted across the coolant flow field channels, for example, the coolant flow field channels 322, 324 in a manner discussed herein with respect to any of the above embodiments.

Furthermore, FIG. 8 illustrates an embodiment of the present invention in which no fluids are directed in a volume 307a of the coolant flow field channels 321 toward a first edge of the flow field plate 305. This volume 307a may be blocked by an obstruction medium 328, such as a solid body, bonding material or any other material or form adapted to occupy the volume 307a to prevent fluid flow therethrough when the fuel cell stack 300 is in operation. Furthermore, a small volume of fluids are directed toward a second edge of the flow field plate 305 in a volume 307b formed by the dividing member 326 in coolant flow field channel 322, which forms one boundary of the volume 307b. Furthermore, through some coolant flow field channels, for example, those toward a center of the flow field plate 305 such as the coolant flow field channel 324, a larger volume of fluids can be directed in volumes 307c than through the volume 307b toward the second edge of the flow field plate 305. The volumes 307c are divided by a dividing member 326; therefore, if desired, coolants having distinct flow characteristics and distinct compositions can be circulated through the respective volumes 307c. Alternatively, one of the volumes 307c can seal in a fluid, such as air.

In any of the embodiments described herein, the dividing member 126, 226, 326 may comprise thermal insulation properties obtained through a material of the dividing member 126, 226, 326 and/or an insulating coating applied to at least a portion thereof for a particular application of the fuel cell stack 100, 200, 300. Furthermore, in any of the embodiments described, the dividing member 126, 226, 326 can be fluid-tight to fluidly isolate the volumes thereof.

The following describes an example of an embodiment of a method of selectively controlling characteristics of distinct cooling media through distinct isolated flow field channels 122, 124 separated by a dividing member 126 in a fuel cell stack according to one embodiment, such as the stack 100 illustrated in FIGS. 5 and 6. The method may include configuring the reactant flow field channels 118, 120 to substantially optimize a flow of reactants. The method may further include forming the coolant flow field channels 122, 124 to substantially balance the configuration of the reactant flow field channels 118, 120. The method further comprises positioning the coolant flow field channels 122 of one flow field plate 106 substantially opposite the coolant flow field channels 124 of an adjacent flow field plate 108 to define an aggregate volume between each pair of opposing coolant flow field channels 122, 124. The method further includes dividing each aggregate volume into at least two volumes 107a, 107b and directing at least two fluids through the at least two volumes 107a, 107b, respectively, the at least two fluids comprising at least one of distinct flow characteristics and distinct compositions, to variably manage a rate of cooling in at least one of distinct regions of each fuel cell 102 and distinct regions of the fuel cell stack 100. The flow characteristics include the flow rate as discussed herein.

In some embodiments, the method may include directing lesser or no cooling media through isolated volumes 107a, 107b of the coolant flow field channels 122, 124 positioned toward an end of at least one fuel cell 102 and/or the fuel cell stack 100. In some embodiments, the two distinct fluids may respectively include air and a cooling medium. In some embodiments, the two distinct fluids may respectively comprise distinct cooling media. In some embodiments, the two distinct fluids may respectively comprise air, water and/or glycol.

In some embodiments, the method may comprise directing a larger flow rate of cooling media through one of the two volumes 107a, 107b adjacent the flow field plate 106 of at least one fuel cell 102 proximate the anode electrode layer 109 of the at least one fuel cell 102 to cool a region proximate the anode electrode layer 109 of the at least one fuel cell 102 more than cooling a region proximate the cathode electrode layer 111 of the at least one fuel cell 102.

In some embodiments, the method may comprise directing a larger flow rate of cooling media through one of the two volumes 107a, 107b adjacent the flow field plate 106 of at least one fuel cell 102 proximate the cathode electrode layer 111 of the at least one fuel cell 102 to cool a region proximate the cathode electrode layer 111 of the at least one fuel cell 102 more than cooling a region proximate the anode electrode layer 109 of the at least one fuel cell 102.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A flow field plate assembly for use in a fuel cell stack having more than one fuel cell, each fuel cell including a membrane electrode assembly (MEA) having an ion-exchange membrane interposed between anode and cathode electrode layers, the flow field plate assembly comprising:
a first flow field plate positionable on an anode side of the MEA of a first fuel cell, at least one reactant flow field channel formed in at least a portion of a first side of the first flow field plate adapted to direct a fuel to at least a portion of the anode electrode layer of the first fuel cell;
a second flow field plate positionable on a cathode side of the MEA of a second fuel cell, adjacent the first fuel cell, at least one reactant flow field channel formed in at least a portion of a first side of the second flow field plate adapted to direct an oxygen-containing gas to at least a portion of the cathode electrode layer of the second fuel cell;
at least one coolant flow field channel formed in at least a portion of a second side of the first and second flow field plates, respectively, the coolant flow field channels of the second side of the first flow field plate being positioned substantially opposite the coolant flow field channels of the second side of the second flow field plate to define an aggregate volume therebetween configured to direct a cooling medium therethrough; and
at least one dividing member extending across at least one coolant flow field channel of at least one of the second sides to selectively divide the aggregate volume into at least first and second volumes, the first volume being configured to circulate or seal a first fluid having a first flow characteristic when circulated and a first composition, and the second volume being configured to circulate or seal a second fluid having a second flow characteristic when circulated and a second composition, to allow selective control over an aggregate cooling characteristic of the fuel cell stack, when the flow field plate assembly is installed in the fuel cell stack and the fuel cell stack is in operation.

2. The flow field plate assembly of claim 1 wherein the second side of the first and second flow field plates of adjacent fuel cells comprise more than one opposing coolant flow field channels forming more than one aggregate volume and the dividing member divides each aggregate volume into at least two distinct volumes configured to circulate distinct cooling media therethrough, when the flow field plate assembly is installed in the fuel cell stack and the fuel cell stack is in operation.

3. The flow field plate assembly of claim 2 comprising more than one dividing member wherein each aggregate volume is divided by a distinct dividing member.

4. The flow field plate assembly of claim 1 wherein the first and second volumes comprise distinct dimensions.

5. The flow field plate assembly of claim 1 wherein the first and second volumes are fluidly isolated from each other.

6. The flow field plate assembly of claim 1 wherein at least one of the reactant and coolant flow field channels comprises a trapezoidal cross-sectional shape having at least one of linear and curvilinear portions.

7. The flow field plate assembly of claim 1 wherein the dividing member is mounted at an angle with respect to the first and second flow field plates.

8. The flow field plate assembly of claim 1 wherein the dividing member is curvilinear.

9. A fuel cell stack comprising:
more than one fuel cell, each fuel cell including a membrane electrode assembly (MEA) having an ion-exchange membrane interposed between anode and cathode electrode layers, a first flow field plate positioned on an anode side of the MEA, at least one reactant flow field channel formed in at least a portion of a first side of the first flow field plate adapted to direct a fuel to at least a portion of the anode electrode layer, a second flow field plate positioned on a cathode side of the MEA, at least one reactant flow field channel formed in at least a portion of a first side of the second flow field plate adapted to direct an oxygen-containing gas to at least a portion of the cathode electrode layer, at least one coolant flow field channel formed in at least a portion of a second side of the first and second flow field plates, respectively, the coolant flow field channels of the second side of the first flow field plate of each fuel cell respectively positioned substantially opposite the coolant flow field channels of the second side of the second flow field plate of an adjacent fuel cell to define an aggregate volume therebetween configured to direct a cooling medium therethrough; and
at least one dividing member extending across at least one coolant flow field channel of at least one of the second sides to selectively divide the aggregate volume into at least first and second volumes, the first volume being configured to circulate or seal a first fluid having a first flow characteristic when circulated and a first composition, and the second volume being configured to circulate or seal a second fluid having a second flow characteristic when circulated and a second composition, to allow selective control over an aggregate cooling characteristic of the fuel cell stack, when the flow field plate assembly is installed in the fuel cell stack and the fuel cell stack is in operation.

10. The fuel cell stack of claim 9 wherein the second side of the first and second flow field plates of adjacent fuel cells comprise more than one opposing coolant flow field channels forming more than one aggregate volume and the dividing member divides each aggregate volume into at least two distinct volumes configured to circulate distinct cooling media therethrough, when the fuel cell stack is in operation.

11. The fuel cell stack of claim 10 comprising more than one dividing member wherein each aggregate volume is divided by a distinct dividing member.

12. The fuel cell stack of claim 9 wherein the first and second volumes comprise distinct dimensions.

13. The fuel cell stack of claim 9 wherein the first and second volumes are fluidly isolated from each other.

14. The fuel cell stack of claim 9 wherein the adjacent first and second flow field plates are integral, forming a bipolar flow field plate, and the second sides of the first and second flow field plates opposing the MEAs of the adjacent fuel cells form inner sides of the bipolar flow field plate and include the coolant flow field channels, respectively.

15. The fuel cell stack of claim 9 wherein at least one of the reactant and coolant flow field channels comprises a trapezoidal cross-sectional shape having at least one of linear and curvilinear portions.

16. The fuel cell stack of claim 9 wherein the dividing member is mounted at an angle with respect to the first and second flow field plates.

17. The fuel cell stack of claim 9 wherein the dividing member is curvilinear.

18. A method of selectively managing cooling characteristics of a fuel cell stack in distinct regions thereof, the fuel cell stack having a plurality of fuel cells, each fuel cell comprising a membrane electrode assembly (MEA) having an ion-exchange membrane interposed between anode and cathode electrode layers, at least one flow field plate interposed between the MEAs of adjacent fuel cells, the flow field plates forming a plurality of coolant flow field channels on a side of the flow field plates opposing the MEAs and a plurality of reactant flow field channels on a side of the flow field plates adjacent the MEAs, the method comprising:
positioning the coolant flow field channels of each flow field plate substantially opposite the coolant flow field channels of an adjacent flow field plate to define an aggregate volume between each pair of opposing coolant flow field channels;
dividing each aggregate volume into at least two volumes; and
at least one of directing and sealing at least two fluids through the at least two volumes, respectively, the two fluids comprising at least one of distinct flow characteristics when circulated and distinct compositions, to variably manage a rate of cooling in at least one of distinct regions of each fuel cell and distinct regions of the fuel cell stack.

19. The method of claim 18 wherein at least one of the two fluids comprises a cooling medium and the method further comprises:
directing a lesser flow rate of cooling media through at least one of the two volumes of the coolant flow field channels positioned toward an end of at least one of the fuel cell stack and at least one fuel cell.

20. The method of claim 18 wherein the two fluids respectively comprise air and a cooling medium.

21. The method of claim 18 wherein the two fluids respectively comprise distinct cooling media.

22. The method of claim 18 wherein one of the two fluids comprises air and the other of the two fluids comprises at least one of water and glycol.

23. The method of claim 18, further comprising:
directing a larger flow rate of a first fluid through one of the two volumes adjacent the flow field plate of at least one fuel cell proximate the anode electrode layer of the at least one fuel cell to cool a region proximate the anode electrode layer more than a region proximate the cathode electrode layer of the at least one fuel cell.

24. The method of claim 18, further comprising:
directing a larger flow rate of a first fluid through one of the two volumes adjacent the flow field plate of at least one fuel cell proximate the cathode electrode layer of the at least one fuel cell to cool a region proximate the cathode electrode layer more than a region proximate the anode electrode layer of the at least one fuel cell.
